(19) United States
(12) Patent Application Publication
(10) Pub. No.: US 2024/0328659 A1
(43) Pub. Date: Oct. 3, 2024

(54) AIR VOLUME CORRECTION CONTROL METHOD AND DEVICE FOR AIR CONDITIONER INDOOR UNIT AND MULTI-SPLIT AIR CONDITIONING UNIT

(71) Applicant: Guangdong Carrier HVAC Co., Ltd., Foshan (CN)

(72) Inventors: Junzhao Xiao, Foshan (CN); Ting Fang, Foshan (CN)

(21) Appl. No.: 18/621,389

(22) Filed: Mar. 29, 2024

(30) Foreign Application Priority Data
Mar. 31, 2023 (CN) 202310347688.X

(51) Int. Cl. F24F 11/77; F24F 11/64

(52) U.S. Cl. CPC F24F 11/77; F24F 11/64

(57) ABSTRACT

An air conditioner indoor unit air volume correction control method includes: presetting a preset rotation speed; setting a sampled rotation speed Fₛ, and collecting corresponding sampled powers when operating in different static pressure intervals at the sampled rotation speed Fₛ and in the condition of a constant air volume, and recording them as a sampled power data set Wₛ; operating the air conditioner indoor unit at the sampled rotation speed Fₛ, and collecting in real time an actual power Wₛ′ when operating at the sampled rotation speed Fₛ; calculating a power deviation rate e based on the sampled power data set Wₛ and the actual power Wₛ′; and acquiring a minimum power deviation rate eₘᵢₙ through comparison, and acquiring the actual static pressure value and the preset rotation speed Fₓ corresponding to the actual static pressure value based on the sampled power corresponding to the minimum power deviation rate eₘᵢₙ.

### CROSS REFERENCE TO RELATED APPLICATIONS

This application claims priority to Chinese Patent Application No. 202310347688.X filed on Mar. 31, 2023, which is incorporated by reference herein in its entirety.

### TECHNICAL FIELD

The invention relates to the field of air conditioners, and specifically relates to an air volume correction control method and device for an air conditioner indoor unit and a multi-split air conditioning unit.

### BACKGROUND

With the development of economy and society, the requirements for carbon dioxide emissions are becoming more and more stringent. Statistics show that the total amount of energy consumption in buildings is increasing year by year, and its proportion in total energy consumption has increased from 10% in the late 1970s to 27.8% in recent years. In energy consumption in buildings, heating and air conditioning consume the most energy. China's energy consumption in heating and air conditioning accounts for 55% of the total energy consumption in buildings. The energy saving of air conditioning systems is of great significance in improving the effectiveness of reducing the total energy consumption in buildings.

The existing air volume correction control for the indoor unit fan of a multi-split machine uses a dial to select a preset rotation speed to achieve air volume correction. However, the number of dials limits the number of preset rotation speeds, and in actual engineering installation, due to the influences from the shape and length of the air return box and the air supply box, dirt and blockage of the filter, and the like, the static pressure of the air duct is not constant, and the air volume cannot be corrected accurately based on the static pressure of the air duct, which affects the use effect.

The prior art (CN113108443A) discloses a method for controlling the constant air volume of a fan coil, which includes pre-testing the corresponding preset rotation speed and preset output power of the fan coil in different static pressure intervals; testing the corrected rotation speeds of the fan coil with respect to the standard temperature value and the standard humidity value in different conditions of the first temperature value and the first humidity value; when the fan coil is operating, first operating at a preset rotation speed F10 at a static pressure of 100 Pa with an actual power SW10 at this time; identifying the final rotation speed based on the comparison between the actual power SW and the pre-tested preset power W; if the actual power SW10 meets a first condition, determining F10 as the final rotation speed automatically identified; if the actual power SW10 meets a second condition, operating at a preset rotation speed F11 at a static pressure of 110 Pa with an actual power SW11 at this time; and if the actual power SW10 meets a third condition, operating at a preset rotation speed F9 at a static pressure of 90 Pa with an actual power SW9 at this time. Although this technical solution also relates to the correction of rotation speed of the fan, it is necessary to keep the air volume constant and to make multiple times of determination and debugging, which is time-consuming and has low operating efficiency.

### SUMMARY OF THE INVENTION

In view of the problems mentioned above, the invention provides an air volume correction control method and device for an air conditioner indoor unit and a multi-split air conditioning unit with a simple method and high operating efficiency, which can timely and accurately correct the final static pressure of the air duct influenced by the shape and length of the air return box and the air supply box, the dirt and blockage of the filter, and the like to adjust the rotation speed of the fan, thereby improving the use effect for the user, avoiding energy waste, and achieving the purpose of energy saving. Even when the air volume is not constant, the static pressure data can be obtained by acquiring the minimum power deviation between the actual power and the sampled power, which reduces the difficulty of acquisition of the static pressure data and improves the precision of acquisition of the static pressure data.

Disclosed is an air volume correction control method for an air conditioner indoor unit, including the following steps:
a presetting step: presetting a corresponding rotation speed of the air conditioner indoor unit when operating at a constant air volume and in different static pressure intervals respectively, and recording it as a preset rotation speed Fₓ;
a sampled power data set Wₛ acquisition step: setting a sampled rotation speed Fₛ, collecting corresponding sampled powers of the air conditioner indoor unit when operating in the different static pressure intervals respectively at the sampled rotation speed Fₛ and in the condition of the constant air volume, and recording them as the sampled power data set Wₛ;
an actual power acquisition step: operating the air conditioner indoor unit at the sampled rotation speed Fₛ, and collecting in real time an actual power Wₛ′ of the air conditioner indoor unit when operating at the sampled rotation speed Fₛ;
a computation step: calculating a power deviation rate e of the air conditioner indoor unit based on the sampled power data set Wₛ acquired in the sampled power data set Wₛ acquisition step and the actual power Wₛ′ acquired in the actual power acquisition step; where,

$$e = \frac{Ws - {Ws}^{′}}{Ws} * 100 \%$$

a comparison step: acquiring a minimum power deviation rate eₘᵢₙ through comparison based on the computation result of the computation step; and
a rotation speed determination step: determining an actual static pressure value of the air conditioner indoor unit in the actual power acquisition step based on the minimum power deviation rate eₘᵢₙ and the sampled power corresponding thereto, and based on the correspondence between the different static pressure intervals and the preset rotation speed Fₓ in the presetting step, determining the preset rotation speed Fₓ corresponding to the actual static pressure value as the final identified rotation speed of the air conditioner indoor unit.

In the control method, the sampled power closest to the actual power is acquired by calculating the minimum power deviation rate, and the actual static pressure is acquired based on the correspondence between the sampled power and the corresponding static pressure. The actual static pressure value is actually the actual static pressure acquired in consideration of influences from comprehensive factors such as the shape and length of the air return box and the air supply box, dirt and blockage of the filter, the temperature and humidity, and the like, so that the accuracy of the actual static pressure data is improved and the difficulty of acquisition of the actual static pressure is reduced, and the drawback in the prior art of incapability or inconvenience of static pressure data measurement by the air conditioning unit itself is also overcome, thereby saving costs. Further, in the control method of the invention, the final identified rotation speed can be determined through computation and comparison steps after collecting the actual power without multiple times of determination and debugging, thereby reducing the complexity of computation and increasing the speed of computation, and the rotation speed of the air conditioner indoor unit can be corrected timely based on the actual power, thereby improving the timeliness and precision of rotation speed adjustment. In addition, in the actual operation steps, the final identified rotation speed can be obtained based on the measured actual power without keeping the air volume constant, which overcomes the influence of inconstant air volume on the correction control method. The air volume correction control method for an air conditioner indoor unit of the invention has the advantages of simplicity, wide application range, and fast computation speed. It improves the timeliness of air volume correction for a multi-split indoor unit to allow the multi-split machine to operate at the correct rotation speed, which is favorable for saving of energy consumption and improves the cooling or heating effect and hence improves the user experience.

Optionally, the method further includes, before the presetting step, a preset rotation speed acquisition step: measuring the corresponding rotation speeds of the air conditioner indoor unit when operating in the condition of a constant air volume and in different static pressure intervals respectively; where in the presetting step, the preset rotation speed Fₓ is set based on the acquisition result of the preset rotation speed acquisition step. The corresponding rotation speeds during operation in different static pressure intervals may be acquired at a constant air volume, which is favorable for improving the accuracy of the preset rotation speed.

Optionally, in the preset rotation speed acquisition step, the static pressure data is measured and acquired by using a static pressure meter. The static pressure data of the air conditioner indoor unit may be acquired by using the static pressure meter, which is simple and fast and reduces the difficulty of the correction control method.

Optionally, the actual power acquisition step is performed after the air conditioner indoor unit enters the automatic identification function. The actual power acquisition step may be performed after the air conditioner indoor unit enters the automatic identification function, which is favorable for improving the accuracy of the actual power data.

Optionally, in the computation step, each sampled power in the sampled power data set Wₛ is compared with the actual power respectively to calculate the power deviation rate e. According to this technical solution, in the condition that the actual static pressure is unknown, the minimum power deviation rate is acquired by calculating the power deviation rate between the sampled powers corresponding to different static pressures respectively and the actual power, and the sampled power closest to the actual power in the sampled power data set and the static pressure corresponding to this sampled power can be acquired, this static pressure being the actual static pressure, which improves the precision of static pressure data acquisition and consequently is favorable for improving the precision of air volume correction.

Optionally, in the presetting step, the numerical range of the different static pressure intervals is 0-200 Pa. According to this technical solution, by selecting an appropriate static pressure interval, both the breadth of air volume correction and the computation amount in the air volume correction method can be taken into account, and the efficiency of the air volume correction method can be improved.

Optionally, in the presetting step, the number of the preset rotation speeds is no less than 10. According to this technical solution, dividing the static pressure interval into smaller intervals can increase the number of preset rotation speeds accordingly, so that different static pressure data have corresponding preset rotation speeds, which is favorable for improving the precision in rotation speed adjustment and the precision in air volume correction for the indoor unit, avoiding unnecessary energy consumption, and improving the energy saving performance of air conditioners.

Optionally, the sampled rotation speed Fₛ is different from the preset rotation speed. According to this technical solution, in consideration of the influence from comprehensive factors such as the shape and length of the air return box and the air supply box, the dirt and blockage of the filter, the temperature and humidity, and the like, an appropriate sampled rotation speed is selected for operation, which helps to narrow the gap between the actual power and the sampled power, so that the minimum power deviation rate is lower, thereby improving the accuracy of the actual static pressure data and consequently matching the accurate preset rotation speed, and improving the accuracy of the air volume correction for the multi-split indoor unit.

Also disclosed is an air volume correction control device for an air conditioner indoor unit, including:
a presetting module configured to preset a corresponding rotation speed of the air conditioner indoor unit when operating at a constant air volume and in different static pressure intervals respectively, and record it as a preset rotation speed Fₓ;
a sampled power data set Wₛ acquisition module configured to set a sampled rotation speed Fₛ, collect corresponding sampled powers of the air conditioner indoor unit when operating in the different static pressure intervals respectively at the sampled rotation speed Fₛ and in the condition of the constant air volume, and record them as the sampled power data set Wₛ;
an actual power acquisition module configured to operate the air conditioner indoor unit at the sampled rotation speed Fₛ, and collect in real time an actual power Wₛ′ of the air conditioner indoor unit when operating at the sampled rotation speed Fₛ;
a computation module communicatively connected with the sampled power data set Wₛ acquisition module and the actual power acquisition module and configured to calculate a power deviation rate e of the air conditioner indoor unit based on the sampled power data set Wₛ acquired by the sampled power data set Wₛ acquisition module and the actual power Wₛ′ acquired by the actual power acquisition module; where,

$$e = \frac{Ws - {Ws}^{′}}{Ws} * 100 \%$$

a comparison module communicatively connected with the computation module and configured to acquire a minimum power deviation rate eₘᵢₙ through comparison based on the computation result of the computation module; and
a rotation speed determination module communicatively connected with the presetting module and the comparison module and configured to determine an actual static pressure value of the air conditioner indoor unit in the actual power acquisition module based on the minimum power deviation rate eₘᵢₙ and the sampled power corresponding thereto, and based on the correspondence between the different static pressure intervals and the preset rotation speed Fₓ in the presetting module, determine the preset rotation speed Fₓ corresponding to the actual static pressure value as the final identified rotation speed of the air conditioner indoor unit.

Also disclosed is a multi-split air conditioning unit including the air volume correction control device for an air conditioner indoor unit described above.

Further disclosed is a computer-readable storage medium having a computer program stored therein. The computer program, when executed by a processor, implements the steps of the air volume correction control method for an air conditioner indoor unit described above.

With the air volume correction control method for an air conditioner indoor unit, the invention can timely and accurately correct the final static pressure of the air duct influenced by the shape and length of the air return box and the air supply box, the dirt and blockage of the filter, and the like to adjust the rotation speed of the fan, thereby improving the use effect for the user, avoiding energy waste, and achieving the purpose of energy saving.

### BRIEF DESCRIPTION OF THE DRAWINGS

FIG. 1 is a schematic flowchart of an air volume correction control method for an air conditioner indoor unit;

FIG. 2 is a schematic modular structural diagram of an air volume correction control device for an air conditioner indoor unit; and

FIG. 3 is a schematic structural diagram of a multi-split air conditioning unit.

Reference numerals: Presetting module 1; sampled power data set Wₛ acquisition module 2; actual power acquisition module 3; computation module 4; comparison module 5; rotation speed determination module 6; preset rotation speed acquisition module 7; compressor 81; four-way valve 82; throttle valve 83; outdoor heat exchanger 84; outdoor fan 841; indoor unit 85; outdoor fan 841; gas-liquid separator 86; oil separator 87; oil return capillary 88.

### DETAILED DESCRIPTION

The technical solutions in the embodiments of the invention will be clearly and completely described below with reference to the accompanying drawings in the embodiments of the invention. Obviously, the described embodiments are only some of the embodiments rather than all the embodiments of the invention. Based on the embodiments of the invention, all other embodiments obtained by those of ordinary skill in the art without creative efforts shall fall within the scope of protection of the invention.

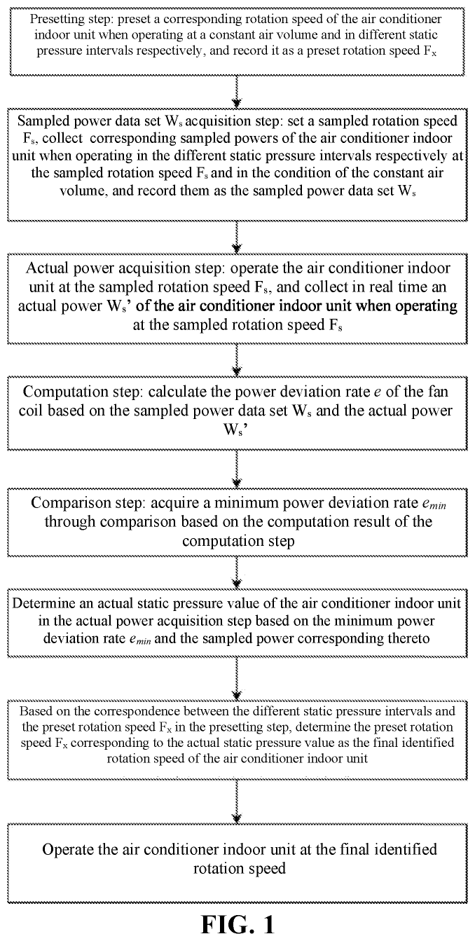

Referring to FIG. 1, this implementation provides an air volume correction control method for an air conditioner indoor unit, including the following steps:
a presetting step: presetting a corresponding rotation speed of the air conditioner indoor unit when operating at a constant air volume and in different static pressure intervals respectively, and recording it as a preset rotation speed Fₓ;
a sampled power data set Wₛ acquisition step: setting a sampled rotation speed Fₛ, collecting corresponding sampled powers of the air conditioner indoor unit when operating in the different static pressure intervals respectively at the sampled rotation speed Fₛ and in the condition of the constant air volume, and recording them as the sampled power data set Wₛ;
an actual power acquisition step: operating the air conditioner indoor unit at the sampled rotation speed Fₛ, and collecting in real time an actual power Wₛ′ of the air conditioner indoor unit when operating at the sampled rotation speed Fₛ;
a computation step: calculating a power deviation rate e of the air conditioner indoor unit based on the sampled power data set Wₛ acquired in the sampled power data set Wₛ acquisition step and the actual power Wₛ′ acquired in the actual power acquisition step; where,

$$e = \frac{Ws - {Ws}^{′}}{Ws} * 100 \%$$

a comparison step: acquiring a minimum power deviation rate eₘᵢₙ through comparison based on the computation result of the computation step; and
a rotation speed determination step: determining an actual static pressure value of the air conditioner indoor unit in the actual power acquisition step based on the minimum power deviation rate eₘᵢₙ and the sampled power corresponding thereto, and based on the correspondence between the different static pressure intervals and the preset rotation speed Fₓ in the presetting step, determining the preset rotation speed Fₓ corresponding to the actual static pressure value as the final identified rotation speed of the air conditioner indoor unit.

In the control method of this implementation, the sampled power closest to the actual power is acquired by calculating the minimum power deviation rate, and the actual static pressure is acquired based on the correspondence between the sampled power and the corresponding static pressure. The actual static pressure value is actually the actual static pressure acquired in consideration of influences from comprehensive factors such as the shape and length of the air return box and the air supply box, the dirt and blockage of the filter, the temperature and humidity, and the like, so that the accuracy of the actual static pressure data is improved and the difficulty of acquisition of the actual static pressure is reduced, and the drawback in the prior art of incapability or inconvenience of static pressure data measurement by the air conditioning unit itself is also overcome, thereby saving costs. Further, in the control method of this implementation, the final identified rotation speed can be determined through computation and comparison steps after collecting the actual power without multiple times of determination, thereby reducing the complexity of computation and increasing the speed of computation, and the rotation speed of the air conditioner indoor unit can be corrected timely based on the actual power, thereby improving the timeliness and accuracy of rotation speed adjustment. In addition, in the actual operation steps, the final identified rotation speed can be obtained based on the measured actual power without keeping the air volume constant, which overcomes the influence of inconstant air volume on the correction control method. The air volume correction control method for an air conditioner indoor unit of this implementation has the advantages of simplicity, wide application range, and fast computation speed. It improves the timeliness of air volume correction for a multi-split indoor unit to allow the multi-split machine to operate at the correct rotation speed, which is favorable for saving of energy consumption and improves the cooling or heating effect and hence improves the user experience.

In an implementation, the method further includes, before the presetting step, a preset rotation speed acquisition step: measuring a corresponding rotation speed of the air conditioner indoor unit when operating in the condition of a constant air volume and in different static pressure intervals respectively; where in the presetting step, the preset rotation speed Fₓ is set based on the acquisition result of the preset rotation speed acquisition step.

In this way, the corresponding rotation speeds during operation in different static pressure intervals are acquired at a constant air volume, which is favorable for improving the accuracy of the preset rotation speed.

In an implementation, in the preset rotation speed acquisition step, the static pressure data is measured and acquired by using a static pressure meter. In laboratory test conditions, the static pressure data of the air conditioner indoor unit is acquired by using the static pressure meter, which is simple and fast and reduces the difficulty of the correction control method.

In an implementation, the actual power acquisition step is performed after the air conditioner indoor unit enters the automatic identification function. In this way, the actual power acquisition step is performed after the air conditioner indoor unit enters the automatic identification function, which is favorable for improving the accuracy of the actual power data. The automatic identification function is an inherent program of the air conditioner that can identify various parameters during the operation of the air conditioner, such as the rotation speed, power, and the like, which will not be described in detail here.

In an implementation, in the computation step, each sampled power in the sampled power data set Wₛ is compared with the actual power respectively to calculate the power deviation rate e.

In this way, in the condition that the actual static pressure is unknown, the minimum power deviation rate is acquired by calculating the power deviation rate between the sampled powers corresponding to different static pressures respectively and the actual power, and the sampled power closest to the actual power and the static pressure corresponding to this sampled power can be acquired, this static pressure being the actual static pressure, which improves the precision of static pressure data acquisition and consequently is favorable for improving the precision of air volume correction.

In an implementation, the air conditioner indoor unit is a duct type air conditioner indoor unit. Duct type air conditioners have the advantages of aesthetic appearance and low cost.

In an implementation, in the presetting step, the numerical range of the different static pressure intervals is 0-200 Pa. By selecting an appropriate static pressure interval, both the breadth of air volume correction and the computation amount in the air volume correction method can be taken into account, and the efficiency of the air volume correction method can be improved. In other approaches, 0-300 Pa and 50-300 Pa can also be selected, which is not limited to the examples given in the implementations of the invention.

In an implementation, in the presetting step, the number of the preset rotation speeds is no less than 10. Dividing the static pressure interval into smaller intervals can increase the number of preset rotation speeds accordingly, so that different static pressure data have corresponding preset rotation speeds, which is favorable for improving the precision in rotation speed adjustment and the precision in air volume correction for the indoor unit, avoiding unnecessary energy consumption, and improving the energy saving performance of air conditioners. Preferably, the number of preset rotation speeds is 21, and the static pressure values are divided in units of 10, including 0, 10, 20, 30, 40, 50 . . . 180, 190, and 200 Pa. Further, in order to improve the precision, the static pressure values can be divided in finer granularity, for example, in units of 5, that is, 0, 5, 10, 15, 20 . . . 190, 195, and 200 Pa.

In an implementation, the method further includes operating the air conditioner indoor unit at the final identified rotation speed after determining the final identified rotation speed. The air volume correction control method for an air conditioner indoor unit according to this implementation has been described above, and will be described below with a specific embodiment.

Specifically, in laboratory conditions, the rotation speed (F₀, F₁, F₂, F₃ . . . . F₂₀) corresponding to the constant air volume at the static pressure of 0 Pa to 200 Pa is tested and recorded as the preset rotation speed Fₓ; the machine is operated at the sampled rotation speed Fₛ, and the corresponding power Wₛᵢ (i=0-20, specifically, Wₛ₀, Wₛ₁, Wₛ₂, Wₛ₃ . . . . Wₛ₂₀) corresponding to the static pressure from 0 Pa to 200 Pa (specifically, 0, 10, 20, 30, 40, 50 . . . 180, 190, 200 Pa) is collected, where the power corresponding to 0 Pa is Wₛ₀, the power corresponding to 10 Pa is Wₛ₁, the power corresponding to 20 Pa is Wₛ₂ . . . and so on; at the engineering installation site, after the air conditioner indoor unit enters the automatic identification function, the power Wₛ′ during operation at the sampled rotation speed Fₛ is collected; the corresponding power deviation rates eⱼ (j=0-20, specifically e₀, e₁, e₂, e₃ . . . e₂₀) at different static pressures are calculated respectively according to the following formula;

$${e}_{j} = \frac{Wsi - {Ws}^{′}}{Wsi} * 100 \%$$

the minimum power deviation rate e min (the minimum in eₘᵢₙ=(e₀, e₁, e₂, e₃ . . . e₂₀)) and the actual static pressure corresponding thereto xxPa are acquired through comparison, and then based on the correspondence between the static pressure and the preset rotation speed, the preset rotation speed Fₓₓ corresponding to the actual static pressure is obtained as the final rotation speed that is automatically identified. For example, the minimum power deviation rate is eₘᵢₙ=e₈, then the master control identifies the corresponding actual static pressure to be 80 Pa, and then in the presetting step, the preset rotation speed F₈ is fetched accordingly as the final rotation speed that is automatically identified.

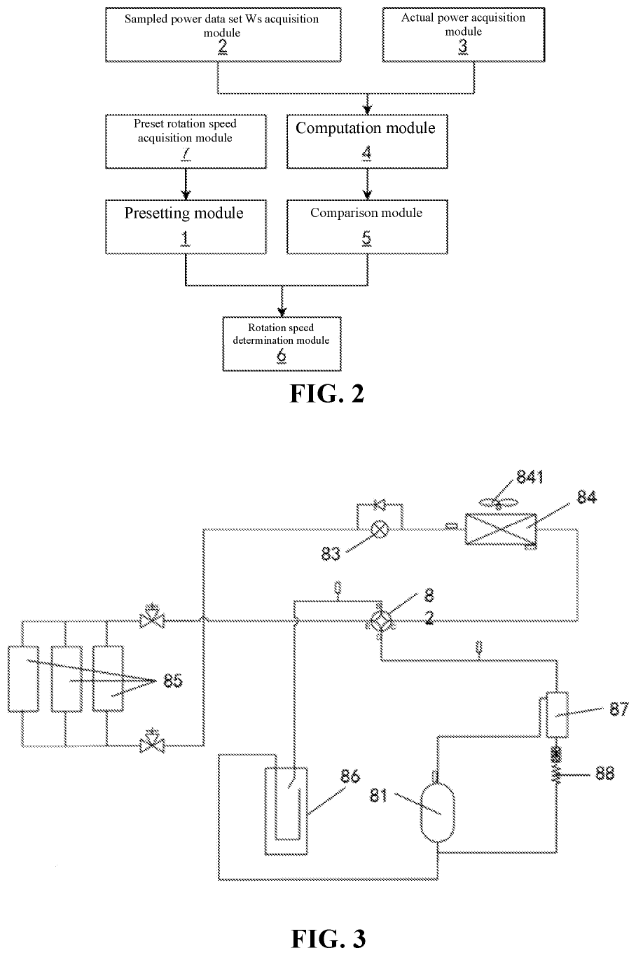

Referring to FIG. 2, this implementation further provides an air volume correction control device for an air conditioner indoor unit, including: a presetting module 1 configured to preset a corresponding rotation speed of the air conditioner indoor unit when operating at a constant air volume and in different static pressure intervals respectively, and record it as a preset rotation speed Fₓ; a sampled power data set Wₛ acquisition module 2 configured to set a sampled rotation speed Fₛ, collect corresponding sampled powers of the air conditioner indoor unit when operating in the different static pressure intervals respectively at the sampled rotation speed Fₛ and in the condition of the constant air volume, and record them as the sampled power data set Wₛ; an actual power acquisition module 3 configured to operate the air conditioner indoor unit at the sampled rotation speed Fₛ, and collect in real time an actual power Wₛ′ of the air conditioner indoor unit when operating at the sampled rotation speed Fₛ; a computation module 4 communicatively connected with the sampled power data set Wₛ acquisition module 2 and the actual power acquisition module 3 and configured to calculate a power deviation rate e of the air conditioner indoor unit based on the sampled power data set Wₛ acquired by the sampled power data set Wₛ acquisition module 2 and the actual power Wₛ′ acquired by the actual power acquisition module 3; where,

$$e = \frac{Ws - {Ws}^{′}}{Ws} * 100 \%$$

a comparison module 5 communicatively connected with the computation module 4 and configured to acquire a minimum power deviation rate e min through comparison based on the computation result of the computation module 4; and a rotation speed determination module 6 communicatively connected with the presetting module 1 and the comparison module 5 and configured to determine an actual static pressure value of the air conditioner indoor unit in the actual power acquisition module based on the minimum power deviation rate eₘᵢₙ and the sampled power corresponding thereto, and based on the correspondence between the different static pressure intervals and the preset rotation speed Fₓ in the presetting module 1, determine the preset rotation speed Fₓ corresponding to the actual static pressure value as the final identified rotation speed of the air conditioner indoor unit.

In an implementation, the air volume correction control device for an air conditioner indoor unit further includes a control module (not shown in the figure). The control module controls the operation of the air conditioner indoor unit based on the final identified rotation speed. Specifically, the preset module 1, the actual power acquisition module 3, the computation module 4, the comparison module 5 and the rotation speed determination module 6 can be partially or fully integrated into the control module, which is preferably the master control board of the air conditioner.

In an implementation, the device further includes a preset rotation speed acquisition module 7 configured to measure the corresponding rotation speeds of the air conditioner indoor unit when operating in the condition of a constant air volume and in different static pressure intervals respectively, so that the presetting module 1 sets the preset rotation speed Fₓ based on the acquisition result of the preset rotation speed acquisition module 7. The preset rotation speed acquisition module 7 can be integrated into the control module, that is, identify the corresponding rotation speeds of the air conditioner indoor unit when operating in the condition of the constant air volume and in different static pressure intervals respectively through the master control board. In other implementations, the static pressure and the corresponding rotation speed can also be manually recorded. The static pressure value is acquired through a static pressure meter in test conditions, which is a simple acquisition approach. The rotation speed is read through the master control board.

In an implementation, the preset rotation speed acquisition module 7 includes a static pressure meter with which the static pressure data is measured and acquired. In laboratory test conditions, the static pressure data of the air conditioner indoor unit is acquired by using a static pressure meter, which is simple and fast and reduces the difficulty of the correction control method.

In an implementation, the actual power acquisition module 3 acquires the actual power after the air conditioner indoor unit enters the automatic identification function. In this way, the actual power acquisition step is performed after the air conditioner indoor unit enters the automatic identification function, which is favorable for improving the accuracy of the actual power data. The automatic identification function is an inherent program of the air conditioner that can identify various parameters during the operation of the air conditioner, such as the rotation speed, power, and the like, which will not be described in detail here.

In an implementation, the computation module 4 compares each sampled power in the sampled power data set Wₛ with the actual power respectively to calculate the power deviation rate e. In the condition that the actual static pressure is unknown, the minimum power deviation rate is acquired by calculating the power deviation rate between the sampled powers corresponding to different static pressures respectively and the actual power, and the sampled power closest to the actual power and the static pressure corresponding to this sampled power can be acquired, this static pressure being the actual static pressure, which improves the precision of static the pressure data acquisition and consequently is favorable for improving the precision of the air volume correction.

Further, as shown in FIG. 3, this implementation further provides a multi-split air conditioning unit including the air volume correction control device for an air conditioner indoor unit described above. In addition, the multi-split air conditioning unit includes a compressor 81, a four-way valve 82, a throttle valve 83, an outdoor heat exchanger 84, multiple indoor units 85 arranged in parallel, an outdoor fan 841, a gas-liquid separator 86, and the like. Each indoor unit 85 is provided with a corresponding indoor fan (not shown in the figure). Further, an oil separator 87 is also provided between the compressor 81 and the four-way valve 82. An oil return capillary 88 is further provided between the outlet of the oil separator 87 and an air return port of the compressor 81. A heat-exchanger outlet temperature sensing package T3 is provided at the outlet of the outdoor heat exchanger 84, a high pressure sensor is provided between the four-way valve 82 and the oil separator 87, a low pressure sensor is provided between the four-way valve 82 and the gas-liquid separator 86, a low pressure stop valve is provided between the outlet of the four-way valve 82 and the inlet of the indoor unit 85, a high pressure stop valve is provided between the outlet of the indoor unit 85 and the throttle valve 83, one check valve is connected in parallel with each side of the throttle valve 83, and an ambient temperature sensing package is also included. It should be noted that the air volume correction control device or control method for an air conditioner indoor unit of this implementation is not only applicable to the multi-split air conditioning unit shown in FIG. 3, but is also applicable to other forms of air conditioners, specific examples of which are not given here.

The air volume correction control device for an air conditioner indoor unit of this implementation can timely and accurately correct the final static pressure of the air duct influenced by the shape and length of the air return box and the air supply box, the dirt and blockage of the filter, and the like to adjust the rotation speed of the indoor unit fan, thereby improving the use effect for the user, avoiding energy waste, and achieving the purpose of energy saving.

This implementation further provides a computer-readable storage medium having a computer program stored therein. The computer program, when executed by a processor, implements the steps of the air volume correction control method for an air conditioner indoor unit described above.

Described above are merely preferred embodiments of the invention, which are not intended to limit the invention. Any modifications, equivalent substitutions and improvements made within the spirit and principle of the invention shall fall within the scope of protection of the invention.

1. An air volume correction control method for an air conditioner indoor unit, comprising the following steps:
a presetting step: presetting a corresponding rotation speed of the air conditioner indoor unit when operating at a constant air volume and in different static pressure intervals respectively, and recording it as a preset rotation speed Fₓ;
a sampled power data set Wₛ acquisition step: setting a sampled rotation speed Fₛ, collecting corresponding sampled powers of the air conditioner indoor unit when operating in the different static pressure intervals respectively at the sampled rotation speed Fₛ and in the condition of the constant air volume, and recording them as the sampled power data set Wₛ;
an actual power acquisition step: operating the air conditioner indoor unit at the sampled rotation speed Fₛ, and collecting in real time an actual power Wₛ′ of the air conditioner indoor unit when operating at the sampled rotation speed Fₛ;
a computation step: calculating a power deviation rate e of the air conditioner indoor unit based on the sampled power data set Wₛ acquired in the sampled power data set Wₛ acquisition step and the actual power Wₛ′ acquired in the actual power acquisition step; where,
$$e = \frac{Ws - {Ws}^{′}}{Ws} * 100 \%$$
a comparison step: acquiring a minimum power deviation rate eₘᵢₙ through comparison based on the computation result of the computation step; and
a rotation speed determination step: determining an actual static pressure value of the air conditioner indoor unit in the actual power acquisition step based on the minimum power deviation rate eₘᵢₙ and the sampled power corresponding thereto, and based on the correspondence between the different static pressure intervals and the preset rotation speed Fₓ in the presetting step, determining the preset rotation speed Fₓ corresponding to the actual static pressure value as the final identified rotation speed of the air conditioner indoor unit.

2. The air volume correction control method for an air conditioner indoor unit according to claim 1, further comprising, before the presetting step, a preset rotation speed acquisition step: measuring the corresponding rotation speeds of the air conditioner indoor unit when operating in the condition of the constant air volume and in different static pressure intervals respectively; where in the presetting step, the preset rotation speed Fₓ is set based on the acquisition result of the preset rotation speed acquisition step.

3. The air volume correction control method for an air conditioner indoor unit according to claim 1, wherein, in the preset rotation speed acquisition step, static pressure data is measured and acquired by using a static pressure meter.

4. The air volume correction control method for an air conditioner indoor unit according to claim 1, wherein the actual power acquisition step is performed after the air conditioner indoor unit enters an automatic identification function.

5. The air volume correction control method for an air conditioner indoor unit according to claim 1, wherein, in the computation step, each sampled power in the sampled power data set Wₛ is compared with the actual power respectively to calculate the power deviation rate e.

6. The air volume correction control method for an air conditioner indoor unit according to claim 1, wherein, in the presetting step, the numerical range of the different static pressure intervals is 0-200 Pa.

7. The air volume correction control method for an air conditioner indoor unit according to claim 1, wherein, in the presetting step, the number of the preset rotation speeds is no less than 10.

8. The air volume correction control method for an air conditioner indoor unit according to claim 1, wherein the sampled rotation speed Fₛ is different from the preset rotation speed.

9. An air volume correction control device for an air conditioner indoor unit, comprising:
a presetting module configured to preset a corresponding rotation speed of the air conditioner indoor unit when operating at a constant air volume and in different static pressure intervals respectively, and record it as a preset rotation speed Fₓ;
a sampled power data set Wₛ acquisition module configured to set a sampled rotation speed Fₛ, collect corresponding sampled powers of the air conditioner indoor unit when operating in the different static pressure intervals respectively at the sampled rotation speed Fₛ and in the condition of the constant air volume, and record them as the sampled power data set Wₛ;
an actual power acquisition module configured to operate the air conditioner indoor unit at the sampled rotation speed Fₛ, and collect an actual power Wₛ′ of the air conditioner indoor unit when operating at the sampled rotation speed Fₛ;
a computation module communicatively connected with the sampled power data set Wₛ acquisition module and the actual power acquisition module and configured to calculate a power deviation rate e of the air conditioner indoor unit based on the sampled power data set Wₛ acquired by the sampled power data set Wₛ acquisition module and the actual power Wₛ′ acquired by the actual power acquisition module; where,
$$e = \frac{Ws - {Ws}^{′}}{Ws} * 100 \%$$
a comparison module communicatively connected with the computation module and configured to acquire a minimum power deviation rate eₘᵢₙ through comparison based on the computation result of the computation module; and
a rotation speed determination module communicatively connected with the presetting module and the comparison module and configured to determine an actual static pressure value of the air conditioner indoor unit in the actual power acquisition module based on the minimum power deviation rate eₘᵢₙ and the sampled power corresponding thereto, and based on the correspondence between the different static pressure intervals and the preset rotation speed Fₓ in the presetting module, determine the preset rotation speed Fₓ corresponding to the actual static pressure value as the final identified rotation speed of the air conditioner indoor unit.

10. A multi-split air conditioning unit, comprising the air volume correction control device for an air conditioner indoor unit according to claim 8.
